(19) United States
(12) Patent Application Publication
(10) Pub. No.: US 2025/0306931 A1
(43) Pub. Date: Oct. 2, 2025

(54) Software Managed Cache with Hardware Optimization

(71) Applicant: Tenstorrent USA, Inc., Austin, TX (US)

(72) Inventors: Rakesh Shaji Lal, Hamilton (CA); Syed Gilani, Markham (CA); Ljubisa Bajic, Toronto (CA)

(21) Appl. No.: 19/039,606

(22) Filed: Jan. 28, 2025

Related U.S. Application Data
(60) Provisional application No. 63/572,263, filed on Mar. 30, 2024.

(51) Int. Cl. G06F 9/30; G06F 9/38

(52) U.S. Cl. CPC G06F 9/30047; G06F 9/30138; G06F 9/3834

(57) ABSTRACT

Systems and methods related to software managed cache with hardware optimization are disclosed herein. A node in a network of computational nodes may include a core configured as a system cache memory. The core may include a memory that is partitioned into sections and that includes registers, one or more processing units, and a hardware accelerator. The hardware accelerator may monitor communication between the processing unit and the memory and may query, in response to detecting a trigger address, one or more of the memory sections about a requested tag. The hardware accelerator may generate a first output value if data is unavailable for the requested tag or a second output value if the data is available. The hardware accelerator relieves the processing unit of performing sequential load and access operations. The partitioning of the memory allows the hardware accelerator to efficiently search the memory and perform other operations.

### CROSS REFERENCE TO RELATED APPLICATIONS

This application claims the benefit of U.S. Provisional Patent Application No. 63/572,263, filed Mar. 30, 2024, which is incorporated by reference herein in its entirety for all purposes.

### BACKGROUND

Many computing systems that are directed to accelerating artificial intelligence workloads, such as the execution of an artificial neural network (ANN) use the paradigm of distributed parallel computing embodied by, for example, a multicore processor. More generally, these systems can be referred to as a network of computational nodes. In a multicore processor, collaboration among multiple cores is essential for efficiently executing ANNs. The parallel architecture of multicore processors allows for simultaneous processing of different portions of the ANN, significantly speeding up training and inference tasks. During the execution of an ANN, various layers and operations can be divided among the available cores, enabling concurrent computation and reducing overall processing time. The cores collaborate through efficient communication mechanisms, such as Networks-on-Chips (NoCs). Coordinated data sharing and synchronization mechanisms are implemented to ensure that intermediate results are exchanged seamlessly, enabling the collective execution of complex neural network models. This collaborative approach optimizes the utilization of available computational resources, enhances parallelism, and contributes to the overall acceleration of AI workloads on multicore processors.

However, despite the advantages of parallelism in multicore processors for ANN execution, efficient data sharing among cores presents a significant challenge. Coordinating the flow of data, particularly data associated with large quantities of network data and intermediate results in the form of activation data, requires careful consideration of communication overhead and synchronization. The interconnectedness of processing cores in a multicore system demands sophisticated communication architectures, like NoCs, to manage the exchange of information without introducing bottlenecks. Balancing the distribution of tasks across cores and minimizing data movement latency is crucial for achieving optimal performance. Additionally, the intricacies of maintaining cache coherence in shared memory architectures can pose challenges, potentially impacting the efficiency gains of parallel processing. Therefore, addressing the complexities of data storage and sharing becomes a critical aspect in the design and optimization of multicore processors for executing neural networks.

### SUMMARY

Systems and methods related to hardware accelerated management of one or more caches implemented by a node within a network of computational nodes are disclosed herein. In specific embodiments of the invention, the cache can be a system cache that is available to be used by alternative nodes within the network of computational nodes. Networks of computational nodes that use shared resources, such as a shared memory, can be beneficial for artificial intelligence workloads because the output of one computational node is often the input to the next computational node. For example, a first computational node could be conducting computations for a first layer of an ANN and a second computational node could be conducting computations for a second layer of an ANN and the second core could start executing as soon as a portion of the data was available as an output from the first layer. As another example, the first computational node could be conducting a large number of multiplication operations and the second computational node could be accumulating the calculated values. In either case, the use of a shared resource such as a shared cache is beneficial because the outputs of one computational unit are readily available to be used as the inputs of a second computational unit.

In specific embodiments of the invention, the memory on one node of the network will be available for use as a cache for alternative nodes on the network. In specific embodiments, the one or more caches can be software configurable. In other words, the partitioning of the cache for one core or another, and the policies and other configurable aspects of the caches may be definable by source code which is compiled for execution by the network of computational nodes. However, using specific embodiments of the inventions disclosed herein, the operation of the caches can be facilitated by hardware accelerators such that specific aspects of their operation are made more efficient despite the fact that the cache is software configurable.

In specific embodiments, a system cache may be implemented on one or more nodes within a network of computational nodes, with the core of the node configured to function as a system cache. Cache memory within a particular node such as L1 cache memory of the core of the particular node may be assigned to function as a system cache node addressable by other nodes (and their associated cores) within the network. The system cache may be allocated to include some or all the L1 cache memory and may be split into sections, including a tag valid section, tag section, data valid section, and data section. Each field within each section may be configurable, and may be associated with corresponding fields within other sections. For example, a particular first tag valid field at a known location within the memory is associated with a particular tag field at a second known location, which is associated with a data valid field at a third known location, and the underlying data for the first tag at a fourth known location.

In specific embodiments, the cache memory of the node may be partitioned such that some of the memory functions as a system cache while other portions of the memory function as a local cache for the node. The node may operate as a computational node, performing operations, in addition to operating as a system cache. Whether a core is repurposed as a system cache and the extent to which a core is repurposed as a system cache may depend on (e.g., be primarily a function of) the computation and memory requirements for the workload of the network.

Aspects of processing circuitry of the core of the system cache node are purposed for hardware acceleration of system cache access operations within the partitioned system cache. For example, rather than a CPU of the core managing each access to locations within the system cache such as via serial load requests from a requesting CPU, a hardware accelerator can monitor CPU load requests for a particular trigger value in such load requests, such as a start address for the tag section of the system cache. When the hardware accelerator identifies the trigger value within the load request, it can perform the underlying operations for a particular request (e.g., of a tag address accessible via configuration logic of the core) such as tag search, tag allocation, tag validity, and data validity and may provide an output corresponding to the results of the system cache operations, such as a value corresponding to a cache “miss” or an address of the data for the requested tag within the data section of the system cache for a tag “hit.” The requesting CPU may access this information via a load request to a register including the result determined by the hardware accelerator.

In specific embodiments of the invention, a system for operating a hardware-accelerated system cache memory within a network of computational nodes is provided. The system comprises a node including a core configured as a system cache memory. The core comprises: a memory partitioned into a plurality of sections and including a plurality of registers and a reduced instruction set computer (“RISC”) processing unit coupled to the memory by a communication path. The RISC processing unit is configured to: send, to a first register of the plurality of registers, a trigger address for the system cache; receive, via a second register of the plurality of registers, a first output value if a requested tag is unavailable; and receive, via the second register of the plurality of registers, a second output value if the requested tag is available. The core further comprises a hardware accelerator coupled to the communication path and configured to: monitor communication between the RISC processing unit and memory for the trigger address; query, in response to the communication including the trigger address, one or more of the plurality of sections of the memory for information about the requested tag; generate the first output value if the information about the requested tag indicates that data is unavailable for the requested tag; generate the second output value if the information about the requested tag indicates that the data is available for the requested tag; and provide the first output value or the second output value to the second register of the plurality of registers based on the query.

In specific embodiments of the invention, a method for operating a hardware-accelerated system cache memory within a network of computational nodes is provided. The method comprises sending, by a RISC processing unit to a first register of a plurality of registers, a trigger address for a system cache memory. The RISC processing unit is coupled to a memory by a communication path. The memory is partitioned into a plurality of sections. The plurality of registers are part of the memory. The memory, the RISC processing unit, and a hardware accelerator are part of a core configured as the system cache memory. The method further comprises monitoring, by the hardware accelerator, communication between the RISC processing unit and the memory for the trigger address. The hardware accelerator is coupled to the communication path. The method further comprises: querying, by the hardware accelerator in response to the communication including the trigger address, one or more of the plurality of sections of the memory for information about a requested tag associated with the trigger address; generating, by the hardware accelerator, a first output value if the information about the requested tag indicates that data is unavailable for the requested tag; generating, by the hardware accelerator, a second output value if the information about the requested tag indicates that the data is available for the requested tag; providing, by the hardware accelerator, the first output value or the second output value to a second register of the plurality of registers based on the query; receiving, by the RISC processing unit and via the second register of the plurality of registers, the first output value if the requested tag is unavailable; and receiving, by the RISC processing unit and via the second register of the plurality of registers, the second output value if the requested tag is available.

In specific embodiments, a system for operating a hardware-accelerated system cache memory within a network of computational nodes is provided. The system comprises a node including a core configured partially as a system cache memory. The core comprises a memory partitioned into a plurality of sections and including a plurality of registers. At least one section of the plurality of sections functions as a system cache for the network of computational nodes and at least one other section of the plurality of sections functions as a local cache for the node. The core further comprises a RISC processing unit coupled to the memory by a communication path. The RISC processing unit is configured to: send, to a first register of the plurality of registers, a trigger address for the system cache; receive, via a second register of the plurality of registers, a first output value if a requested tag is unavailable; and receive, via the second register of the plurality of registers, a second output value if the requested tag is available. The core further comprises a hardware accelerator coupled to the communication path and configured to: monitor communication between the RISC processing unit and the memory for the trigger address; query, in response to the communication including the trigger address, one or more of the at least one section that functions as the system cache for information about the requested tag; generate the first output value if the information about the requested tag indicates that data is unavailable for the requested tag; generate the second output value if the information about the requested tag indicates that the data is available for the requested tag; and provide the first output value or the second output value to the second register of the plurality of registers based on the query.

### BRIEF DESCRIPTION OF THE DRAWINGS

The accompanying drawings illustrate various systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an exemplary network of computational nodes in accordance with specific embodiments of the inventions disclosed herein.

FIG. 2 provides an exemplary network of computational nodes with some nodes utilized for system cache in accordance with specific embodiments of the inventions disclosed herein.

FIG. 3 provides an exemplary computational node operating as system cache in accordance with specific embodiments of the inventions disclosed herein.

FIG. 4 provides an example of a node that is repurposed as system cache with hardware acceleration in accordance with specific embodiments of the inventions disclosed herein.

FIG. 5 provides an exemplary partitioning of an L1 cache of a core of a node to function as a system cache in accordance with specific embodiments of the inventions disclosed herein.

FIG. 6 provides exemplary steps for hardware accelerated system cache access within a system cache operating on a node of a network of computational nodes in accordance with specific embodiments of the inventions disclosed herein.

FIG. 7 provides an exemplary computational node including a core configured as a system cache memory and showing messages between portions of the core in accordance with specific embodiments of the inventions disclosed herein.

FIG. 8 provides an exemplary node partially repurposed as system cache with hardware acceleration, the node maintaining some cache as a local cache, in accordance with specific embodiments of the inventions disclosed herein.

FIG. 9 provides an example of a method for operating a hardware-accelerated system cache memory within a network of computational nodes in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for software managed cache with hardware optimization in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to hardware accelerated management of one or more caches implemented by a node within a network of computational nodes are disclosed herein. In specific embodiments of the invention, the cache can be a system cache that is available to be used by alternative nodes within the network of computational nodes (e.g., the memory on one node of the network will be available for use as a cache for alternative nodes on the network). In specific embodiments, the one or more caches can be software configurable. In other words, the partitioning of the cache for one core or another, and the policies and other configurable aspects of the caches may be definable by source code which is compiled for execution by the network of computational nodes. However, using specific embodiments of the inventions disclosed herein, the operation of the caches can be facilitated by hardware accelerators such that specific aspects of their operation are made more efficient despite the fact that the cache is software configurable.

In specific embodiments, a system cache may be implemented on one or more nodes within a network of computational nodes, with the core of the node configured to function as a system cache. Cache memory within a particular node such as L1 cache memory of the core of the particular node may be assigned to function as a system cache node addressable by other nodes (and their associated cores) within the network. The system cache is allocated to include some or all the L1 cache memory and is split into sections, including a tag valid section, tag section, data valid section, and data section. Each field within each section is configurable, and is associated with corresponding fields within other sections. For example, a particular first tag valid field at a known location within the memory is associated with a particular tag field at a second known location, which is associated with a data valid field at a third known location, and the underlying data for the first tag at a fourth known location.

Aspects of processing circuitry of the core of the system cache node are purposed for hardware acceleration of system cache access operations within the partitioned system cache. For example, rather than a CPU of the core managing each access to locations within the system cache such as via serial load requests from a requesting CPU, a hardware accelerator can monitor CPU load requests for a particular trigger value in such load requests, such as a start address for the tag section of the system cache. When the hardware accelerator identifies the trigger value within the load request, it can perform the underlying operations for a particular request (e.g., of a tag address accessible via configuration logic of the core) such as tag search, tag allocation, tag validity, and data validity and can provide an output corresponding to the results of the system cache operations, such as a value corresponding to a cache “miss” or an address of the data for the requested tag within the data section of the system cache for a tag “hit.” The requesting CPU may access this information via a load request to a register including the result determined by the hardware accelerator.

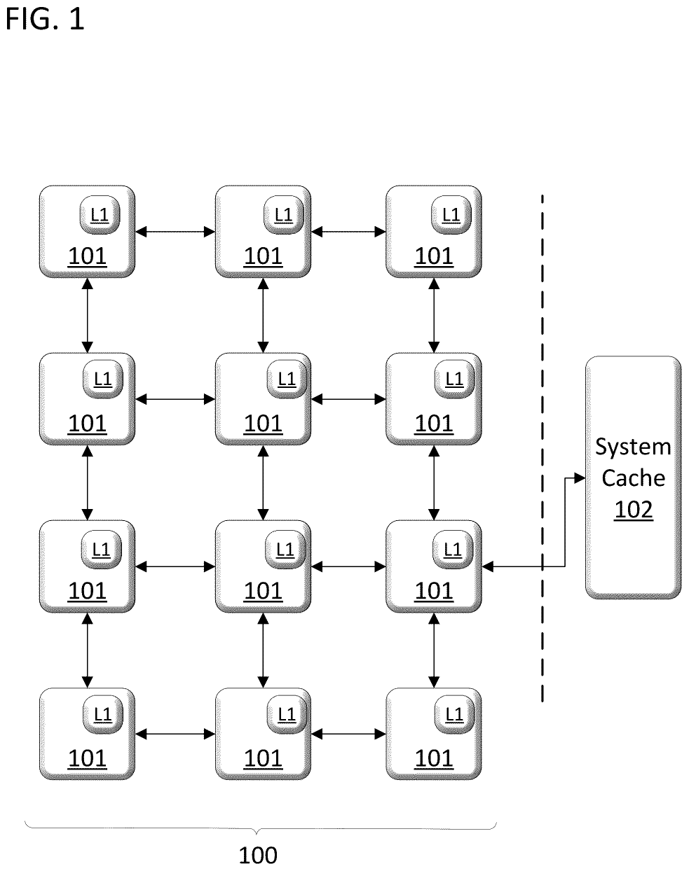

FIG. 1 depicts an exemplary network 100 of computational nodes 101 in accordance with specific embodiments of the inventions disclosed herein. In FIG. 1, a four-row by three-column configuration of nodes 101 in network 100 is depicted, for illustration purposes, in a particular configuration with communication paths between each node 101 and four adjacent nodes 101 (wrapping communication paths, for example, from a right side of a row to a left side of a row or a top of a column to a bottom of a column, and vice versa, not depicted), although it will be understood that the present disclosure applies to any suitable configuration of a network of computational nodes. For example, nodes can be configured in multiple shapes and patterns, with a variety of direct communications paths (e.g., not including only between adjacent nodes).

However the network of computational nodes is configured, the complex operations and computations performed by the network are dynamically allocated between nodes. This allocation requires sequencing of operations, splitting operations and computations between nodes, and management of processing and memory capacity within the network. This management is performed in a manner to optimize usage of the processing cores within each node, which may themselves include multiple processors (e.g., central processing units (“CPUs”), graphics processing units (“GPUs”), and reduced instruction set computer (“RISC”) CPUs) in a variety of combinations and configurations. For example, the management of the network of nodes attempts to maximize utilization, but also must do so in a manner such that the management operations and communications performed within the network do not use excessive processing time, communication bandwidth, and the like.

One example of optimizing the operation of network of computational nodes is to efficiently manage the memory utilization within a network. Accordingly, cache memory such as memory resident on the nodes (e.g., within a core of each node 101) and system cache (e.g., system cache 102) may be utilized for high-speed storage and access to information that needs to be regularly accessed, that is temporarily stored for use in ongoing operations and computations, or that holds current network management information. Accordingly, some cache memory (e.g., an L1 cache) may be located on each node 101 and be accessible to that node 101 for storing information for that node 101, while shared information relevant to multiple nodes 101 may be stored such as in a shared system cache 102 (e.g., an L2 or L3 cache). Although a single communication path between network 100 and system cache 102 is depicted in FIG. 1, it will be understood that system cache 102 (or one of multiple system caches) may be readily accessible to each node 101 via direct connections and/or communication paths through network 100.

In specific embodiments of the invention, one or more nodes 101 of network 100 may be repurposed as system cache. For example, cores of one or more nodes 101 can be repurposed from performing managed operations and computations by configuring the core to function as system cache. This system cache may be present in addition to system cache 102. In specific embodiments, for example, it may be determined that particular nodes 101 within network 100 are being underutilized. Accordingly, these nodes may be reconfigured to function as system cache, with their internal memories (e.g., L1 cache) accessible for cache storage and access requests from other nodes within network 100. For example, shared information relevant to multiple nodes may be stored such as in the shared system cache (e.g., an L1 cache) located in the repurposed node.

Network 100 using shared resources, such as a shared memory (system cache 102 and system cache from a repurposed node), can be beneficial for various workloads. For example, shared resources benefit artificial intelligence workloads because the output of one computational node 101 is often the input to the next computational node 101. For example, a first computational node 101 could be conducting computations for a first layer of an ANN and a second computational node 101 could be conducting computations for a second layer of an ANN and the second core could start executing as soon as a portion of the data was available as an output from the first layer. As another example, the first computational node 101 could be conducting a large number of multiplication operations and the second computational node 101 could be accumulating the calculated values. In either case, the use of a shared resource such as a shared cache is beneficial because the outputs of one computational unit are readily available to be used as the inputs of a second computational unit. Accordingly, increasing the amount of shared cache by repurposing one or more nodes 101 may improve the efficiency of network 100 in completing the workload. The quantity of nodes 101 that are repurposed as shared cache, and the extent to which the nodes are repurposed as shared cache, may depend on computational requirements of the workload.

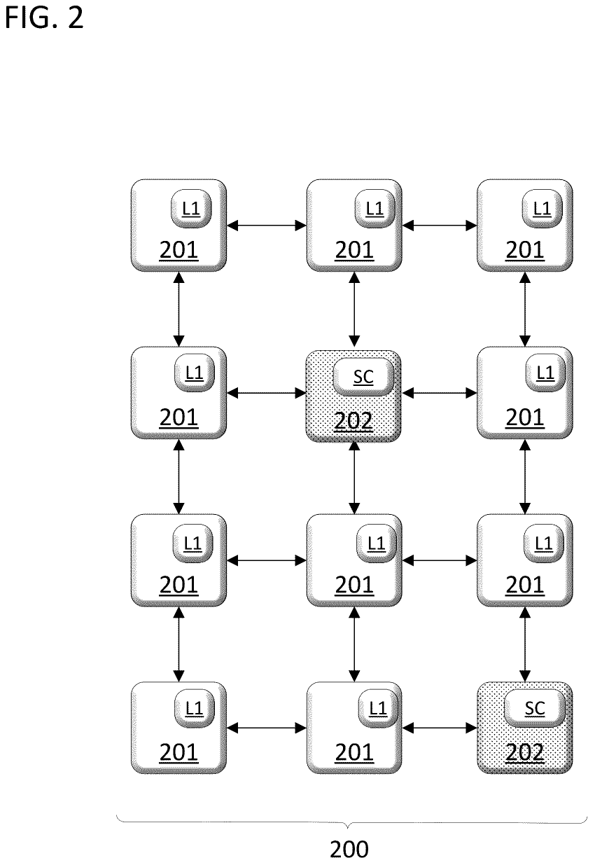

FIG. 2 depicts an exemplary network 200 of computational nodes 201 and 202 with nodes 202 utilized for system cache in accordance with specific embodiments of the inventions disclosed herein. In the network 200 of FIG. 2, nodes 202 (with label “SC”) have been repurposed as system cache. Cores of nodes 202 can be repurposed from performing managed operations and computations by configuring the core to function as system cache. This repurposing can be preconfigured, can be performed dynamically, or both.

For example, in order to have system cache strategically located within a network (e.g., network 200), particular nodes (e.g., nodes 202) may be repurposed to operate as system cache. A repurposed node 202 may be strategically located relative to nodes 201. For example, repurposed node 202 may be physically located away from a system cache so that nodes 201 physically close to repurposed node 202 may have a closer system cache for faster system cache access. As another example, a repurposed node 202 may be located physically close to (e.g., connected directly with) nodes 201 that frequently access a system cache or that use high amounts of memory bandwidth.

During particular operations, it may be determined that network 200 as a whole and/or particular nodes (e.g., nodes 202) within network 200 are being underutilized. Accordingly, these nodes (e.g., nodes 202) may be reconfigured to function as system cache, with their internal memories (e.g., L1 cache) accessible for cache storage and access requests from nodes 201 within network 200. The decision to repurpose node 202 from performing managed operations and computations to functioning as a system cache may be a function of computation requirements of the workload of network 200. Some workloads may not use or need all nodes 201 and 202 for computation purposes, such that the L1 caches of nodes 202 may be repurposed as system caches. Some workloads may be memory intensive such that the additional memory of the repurposed system cache nodes 202 outweighs the loss of active computation nodes.

Modified commands and operations may be preloaded to nodes 202 to perform the operations necessary to function as system cache (e.g., based on receiving a configuration message to operate as system cache) or may be updated such as by dynamically updating code present within the core of the node. A node may operate as a computational node or as system cache based on a setting of the node, for example a setting stored in configuration logic of the node's core. Each core may be programmable to modify the operation of the core. For example, the memory (e.g., L1 cache) of a core may be partitioned into separate sections when a node operates as a system cache and each section of the memory may be configurable.

Nodes 202 may include multiple types of memory. For example, each node 202 may include L1 cache, registers, configuration memory, etc. When repurposed as a system cache, node 202 may designate L1 cache as system memory without designating other portions of the memory of node 202 to system cache (e.g., registers, configuration memory, etc. may not be repurposed as system cache). In specific embodiments, part of the L1 cache of node 202 may be repurposed as system cache while another part of the L1 cache of node 202 may be maintained as a private cache for the node 202. The node 202 may perform workload operations using the private cache portion of the node L1 cache while nodes 201 use the system cache portion of the nodes 202 L1 cache to perform their workload operations.

Nodes 201 may send or refrain from sending memory access requests to nodes 202 based on the configuration of node 202. Nodes 201 may access the system cache of nodes 202 through specific hardware and protocol mechanisms designed to facilitate high-speed data retrieval while maintaining consistency and coherence in shared systems. In specific embodiments, a node 201 may check its local L1 cache for requested data (e.g., cache lookup), comparing a requested address with tags stored in the local L1 cache of the node 201. If the data is not in the local L1 cache of the node 201, then node 201 may forward the request to the system cache of a node 202. In specific embodiments, nodes 201 may check the L1 system cache of nodes 202 before checking higher levels of system cache (e.g., a L3 system cache). In specific embodiments, node 201 may compare the requested address with tags stored in the local L1 cache of the node 201 and with tags stored in the repurposed L1 system cache of a node 202 at the same time.

Nodes 201 may be connected to nodes 202 via a variety of interconnects pathway designs. For example, nodes 201 may be connected to nodes 202 with direct connections, indirect connections, point-to-point connections, shared connections, switched connections, etc. Network 200 may use various topologies. Network 200 may use cache coherence protocols to ensure consistent data across all caches of nodes 201 and 202.

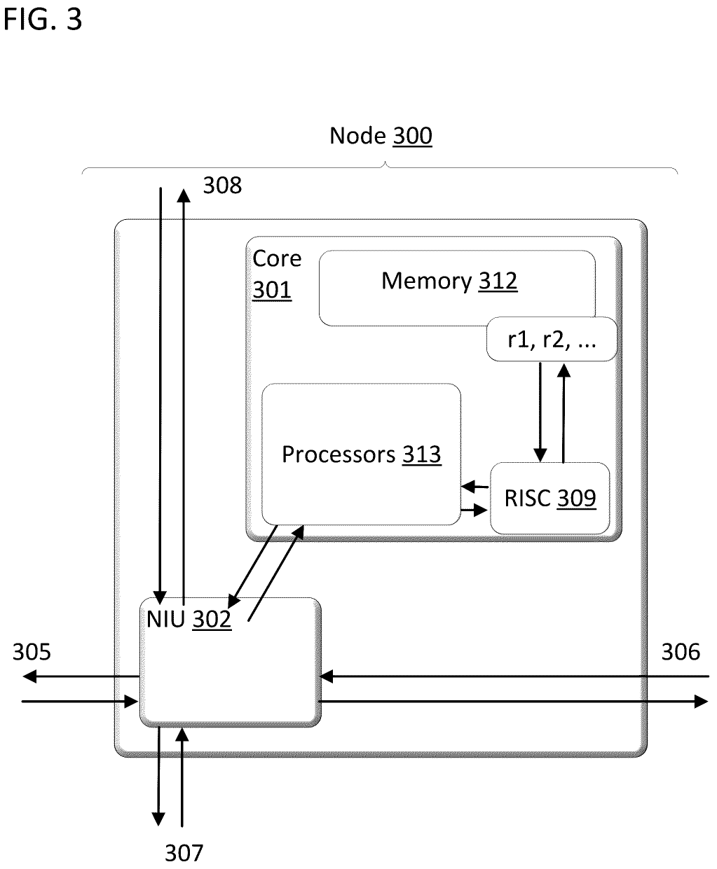

FIG. 3 depicts an exemplary computational node 300 operating as system cache in accordance with specific embodiments of the inventions disclosed herein. The structure and components of node 300 are simplified for purposes of describing the relevant system cache operations for purposes of the present disclosure. For example, while communications between node 300 and other nodes is depicted as via communication paths 305, 306, 307, and 308 via a network interface unit (“NIU”) 302, it will be understood that a variety of communication interfaces and components may be utilized to communicate between nodes, for example, in a network-on-chip (“NoC”) architecture. Further, the NIU is depicted as communicating with core 301, but may be a component of the core or may have functionality split with other components. Moreover, while core 301 is depicted with particular components relevant to the present disclosure including processors 313 (e.g., CPUs, GPUs, etc.), at least one RISC CPU 309, and memory 312 including multiple addressable registers r1, r2, etc., it will be understood that a variety of core hardware configurations may be utilized for a node functioning as system cache.

FIG. 3 depicts node 300 repurposed as system cache including requests received from other nodes (e.g., via communication paths 305, 306, 307, 308 and NIU 302), and provided to one or more of the processors 313 of core 301. Processors 313 of core 301 may parse received messages and communicate cache access requests to RISC CPU 309, which in turn may service the request via requests to registers of memory 312 (e.g., load requests). For example, cached data may include a tag that is utilized to provide an address that can be requested by other nodes as well as associated data for the tag. Upon receiving a request for a tag (e.g., via the other processors), RISC CPU 309 may access tag locations, such as by comparing a requested tag address to locations within memory 312. Although logic may be implemented to optimize this process, these memory access requests may require successive requests from RISC CPU 309 to memory 312 via its registers (e.g., load requests requesting memory 312 to load the content of a particular address within memory 312) until the requested tag address is found, as well as additional operations to confirm data and tag validity.

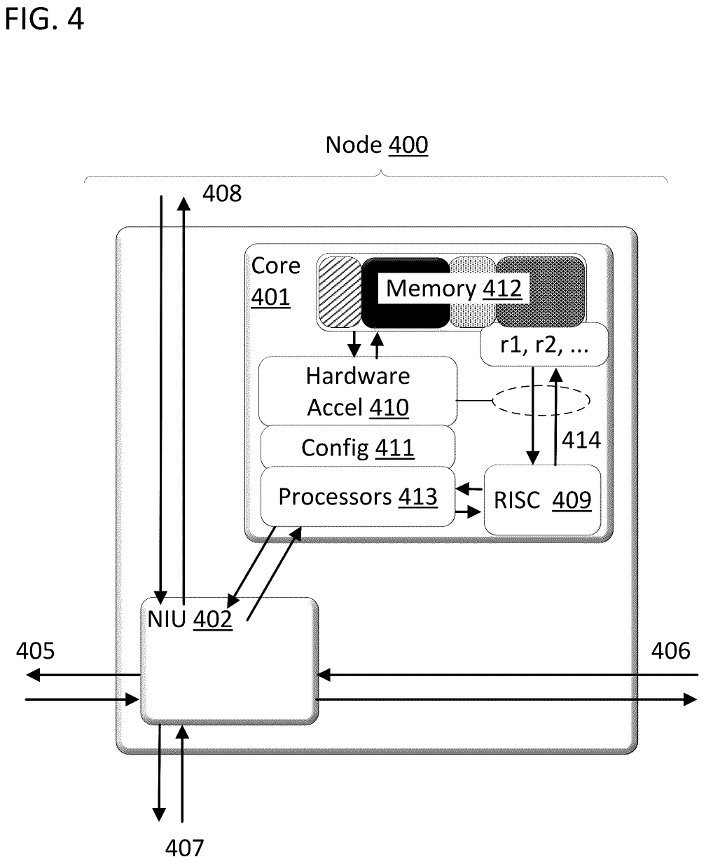

FIG. 4 depicts a node 400 repurposed as system cache with hardware acceleration in accordance with an embodiment of the present disclosure. The structure and components of the node 400 are simplified for purposes of describing the relevant system cache operations for purposes of the present disclosure. For example, while communications between node 400 and other nodes is depicted as via communication paths 405, 406, 407, and 408 via a network interface unit (“NIU”) 402, it will be understood that a variety of communication interfaces and components may be utilized to communicate between nodes, for example, in a network-on-chip (“NoC”) architecture. Further, NIU 402 is depicted as communicating with core 401, but may be a component of the core or may have functionality split with other components. Moreover, while core 401 is depicted with particular components relevant to the present disclosure including processors 413 (e.g., CPUs, GPUs, etc.), at least one RISC CPU 409, a system cache hardware accelerator 410, configuration logic 411 for hardware accelerator 410, and memory 412 including multiple addressable registers r1, r2, etc., it will be understood that a variety of core hardware configurations may be utilized in accordance with the present disclosure.

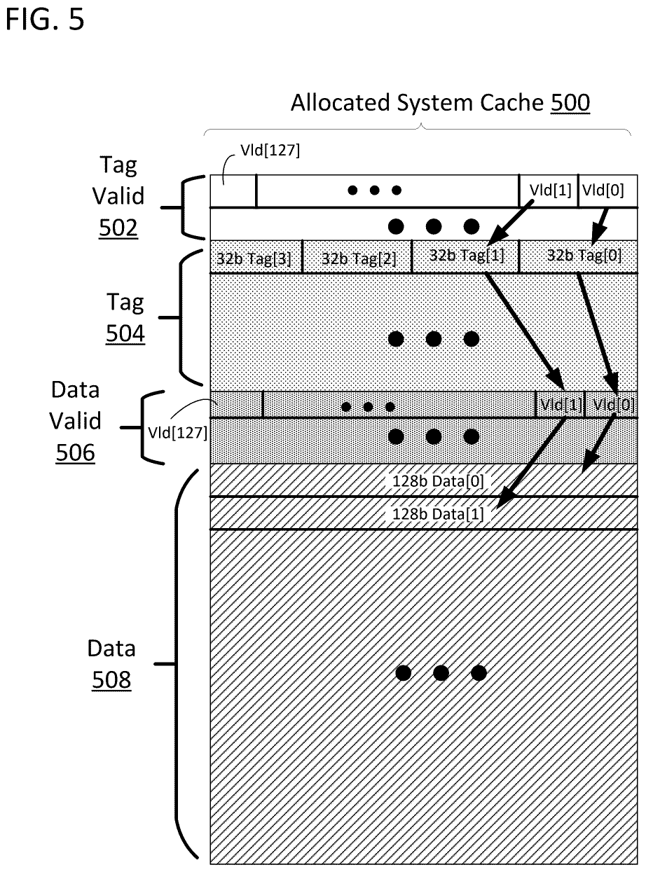

Cache configuration messages and cache access requests are received at core 401, for example, from other nodes within a network via NIU 402 and any of communication paths 405, 406, 407, and/or 408. As is depicted in FIG. 4, RISC CPU 409 communicates with memory 412 of core 401 (e.g., via registers r1, r2, etc.) via communication path 414. Processing core 401 is configured (e.g., via configuration logic 411) to partition the L1 memory into particular sections, described in more detail in connection with FIG. 5. Further, portions of processing core 401 are configured as hardware accelerator 410, that automatically performs system cache management operations of the properly partitioned memory 412 based on configuration logic 411 and messages that are communicated between RISC CPU 409 and memory 412 (e.g., via register load operations), relieving RISC CPU 409 of performing sequential load and access operations to match requested tags to tags within memory 412. The partitioning of memory 412 allows hardware accelerator 410 to efficiently search the memory of the system cache for requested tags and perform other operations such as tag and data validation.

Cache configuration messages may configure core 401 to function as the system cache, for example, by initiating or enabling system cache operation and providing parameters for configuring the cache. For example, configuration of core 401 as a system cache may include explicit allocations of the memory sections, including overall size, tag and data size, number of tags, trigger addresses and the like. In specific embodiments, some or all of the configuration can be modified. In some examples, some or all of the configuration can be performed automatically by core 401, with core 401 providing some or all of the information necessary for the system to address the cache to other nodes. Cache access requests may then trigger hardware accelerated cache access, for example, with another node providing a tag address to access. Operations may be split between RISC CPU 409 and hardware accelerator 410, for example, with RISC CPU 409 providing a load message to a register of memory 412 including the trigger address (e.g., a configured address such as a tag start address that is already an existing address/message for core 401 memory access requests) and with hardware accelerator 410 accessing the requested address via configuration logic 411 to perform the tag search and management operations. For example, hardware accelerator 410 may “snoop” communication path 414 between RISC CPU 409 and the registers of memory 412 for a particular trigger message such as a tag start address, which may trigger hardware accelerator 410 to perform cache access and analysis operations.

FIG. 5 depicts an exemplary partitioning of an L1 cache of a core of a node to function as a system cache in accordance with an embodiment of the present disclosure. Although it will be understood that partitioning may be performed in a variety of manners and configurations, an exemplary partitioning for a system cache with hardware acceleration includes four sections including tag valid section 502, tag section 504, data valid section 506, and data section 508. The relative sizes of the portion of the memory allocated to system cache 500, each of the sections 502, 504, 506, and 508, and the respective data field sizes may be set based on configurations provided to the core functioning as a system cache. The core of the node may be programmable to modify the sections of allocated system cache 500. For example, the core may make a modification to a tag width of a plurality of tags within tag section 504, to a data width of a plurality of data locations within data section 508, to an overall amount of memory allocated to each of the sections 502, 504, 506, and 508 of allocated system cache 500, or a combination of modifications.

In the example depicted in FIG. 5, each section has a set number of fields including a set number of bits, with a one-to-one correlation for respective fields within each section. For example, a tag valid field VId[0] in tag valid section 502 is a single bit with a binary 1/0 value indicating whether a corresponding tag Tag[0] (e.g., a 32-bit tag address that can be requested in accordance with the present disclosure) is valid. The tag field Tag[0] in tag section 504 in turn is associated with a single-bit data valid field VId[0] in data valid section 506 and 128 bit data field Data[0] in data section 508. This architecture, addressing, and associations allows the hardware accelerator to quickly access and update information about a tag based on the known locations and associations set by the system cache configuration.

The hardware accelerator may determine that a tag having a particular tag value has been requested. For example, via the configuration logic, a tag address may be accessed to query for within system cache 500. Upon snooping a trigger address such as a tag start address within the load request from the RISC CPU to a register of the system cache memory, the hardware accelerator begins the hardware accelerator cache operations, such as tag searching, tag search and allocation, tag validity analyses, and data validity analyses. Accordingly, if a tag is requested, the hardware accelerator accesses information about the requested tag to return information about the tag. For example, if the tag is found within any of the fields of the tag section 504 by the hardware accelerator, the hardware accelerator further determines whether the tag is valid (e.g., based on the associated tag valid value within tag valid section 502 and/or additional tag validation and coherence tests) and that the data associated with the tag is valid (e.g., based on the associated data valid value within data valid section 506 and/or additional data validation and coherence tests), and upon determining that the tag and data are valid, returns an address that can be used to access the data associated with the tag (e.g., by the RISC CPU and/or another core or node). In this manner, rather than the RISC CPU sending repeated sequences of load requests to serially review data within system cache 500, the hardware accelerator performs the required operations based on the known partitioning and associations within the system cache, returning the location of the data associated with the tag to the RISC CPU such as via one of the registers.

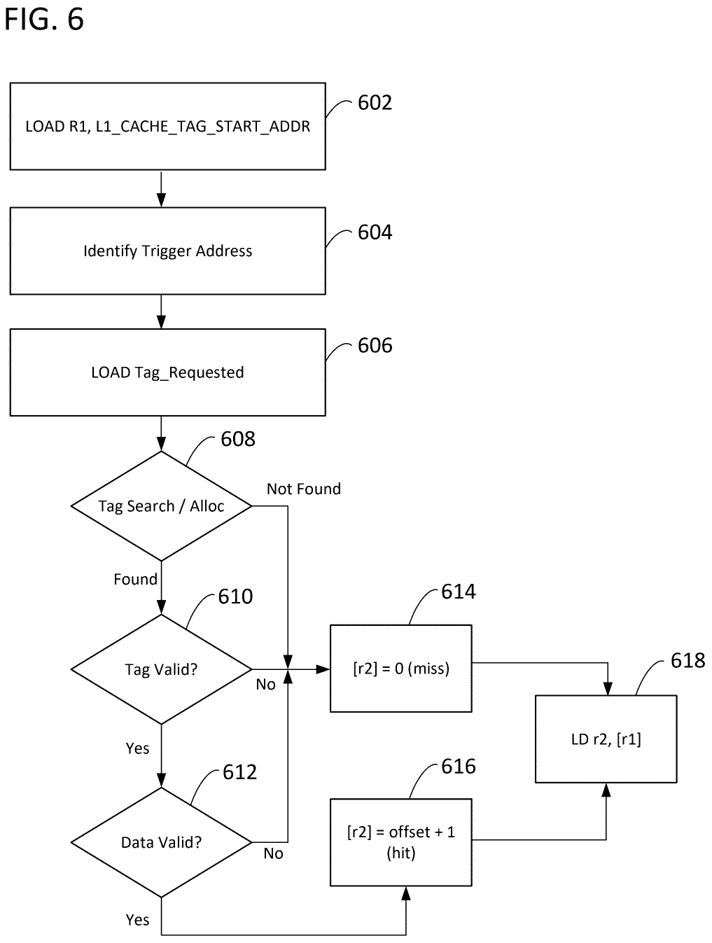

FIG. 6 depicts exemplary steps for hardware accelerated system cache access within a system cache operating on a node of a network of computational nodes in accordance with specific embodiments of the inventions disclosed herein. Although particular steps are depicted in a particular order in FIG. 6, it will be understood that the order of certain steps may be modified in accordance with the present disclosure and that steps may be added or removed in certain embodiments.

At step 602, a RISC CPU sends a load request to a register of the allocated system cache such as a register r1 that includes the trigger address, such as the start address for the tag section of the system cache (e.g., Tag[0] within tag section 504). An example of the RISC program for such a load request is as follows:
LD r1, L1_CACHE_TAG_START_ADDR //Memory-mapped Load into r1, Tag start address

At step 604, the hardware accelerator, which may be monitoring one or more registers of the allocated system cache or snooping the communications path between the RISC CPU and the registers, may identify the address in the load request (e.g., L1_CACHE_TAG_START_ADDR) as the trigger address. Based on identifying the trigger address, the hardware accelerator may continue to step 606 to perform hardware accelerated cache management operations as described herein.

At step 606, the hardware accelerator may access the tag address that is to be processed as well as any additional information (e.g., requested operations such as validations, modifications, etc.) related to the tag address. The tag address is an address that is uniquely associated with data and may be based in whole or in part on addresses within the tag section of the system cache or may be based in whole or in part on values within the tag section having addresses defined elsewhere. Regardless, the tag address can be made available when the hardware accelerator accesses the tag address such as via configuration logic. Once the tag address is available, the hardware accelerator may perform operations within the system cache beginning at step 608.

At step 608, the hardware accelerator may perform tag search and/or tag allocation operations within the tag section of the system cache, for example, by searching for matches of the tag address or performing allocations of tag addresses as requested. If a tag address is found or allocated, processing may continue to step 610. If a tag address is not found or allocated, processing may continue to step 614.

At step 610, the hardware accelerator may perform a tag validity check on the identified tag, for example, by checking a tag valid field associated with the tag or performing verification operations for cache coherence for the tag value. If the tag is determined to be invalid, in addition to updating an associated tag invalid field as appropriate, processing may continue to step 614. If the tag is not determined to be invalid, processing may continue to step 612.

At step 612, the hardware accelerator may perform a data validity check for the data associated with the tag address, for example, based on the binary value of an associated data valid tag, coherence protocols, or cache eviction. If the data associated with the tag is determined to be invalid, in addition to updating an associated data invalid field as appropriate, processing may continue to step 614. If the data associated with the tag is not determined to be invalid, processing may continue to step 612.

If processing continues to step 614, a value associated with a cache “miss” such as a “0” value may be loaded into an appropriate register (e.g., r2) to indicate that a cache miss has occurred, for example, because the tag was not found, the tag was invalid, or the data was invalid. Processing may continue to step 618.

If processing continues to step 616, a value associated with a cache “hit” such as an offset to the address of the data (e.g., an “offset+1” value based on an offset to the data value with an additional increment) may be loaded into an appropriate register (e.g., r2) to indicate that a cache hit has occurred, for example, because the tag was found, the tag was valid, and the data was valid. Processing may continue to step 618.

At step 618, the register value may be loaded by the RISC CPU, such as by a load command. An example load command may be as follows:
LD r2, [r1] //This load triggers the Tag Search HW Engine
   //and loads into r2 Tag Search Result: If miss, 0; If hit, (offset+1)
      That is, the RISC CPU loads the register value, regardless of whether the result of the tag search is a miss or a hit. However, the register value will be 0 if the result is a miss and offset+1 if the result is a hit.

Networks of computational nodes that use shared resources, such as a shared memory, can be beneficial for artificial intelligence workloads because the output of one computational node is often the input to the next computational node. For example, a first computational node could be conducting computations for a first layer of an ANN and a second computational node could be conducting computations for a second layer of an ANN and the second core could start executing as soon as a portion of the data was available as an output from the first layer. As another example, the first computational node could be conducting a large number of multiplication operations and the second computational node could be accumulating the calculated values. In either case, the use of a shared resource such as a shared cache is beneficial because the outputs of one computational unit are readily available to be used as the inputs of a second computational unit.

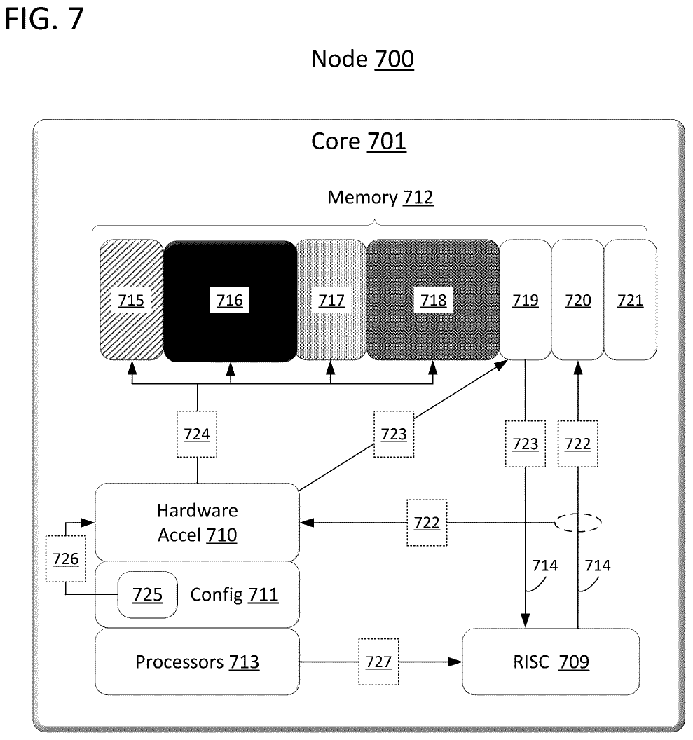

FIG. 7 depicts an exemplary computational node 700 including core 701 configured as a system cache memory showing messages between portions of core 701 in accordance with specific embodiments of the inventions disclosed herein. Node 700 may be part of a network of computational nodes. Core 701 may include memory 712, RISC processing unit 709, and hardware accelerator 710. RISC processing unit 709 may be coupled to memory 712 by communication path 714. Two instances of communication path 714 are depicted in FIG. 7 to clarify the source and destination of messages send along communication path 714, however these two instances may effectively refer to the same communication path. While core 701 is depicted with particular components relevant to the present disclosure including processors 713 (e.g., CPUs, GPUs, etc.), RISC processing unit 709, configuration logic 711, and memory 712, it will be understood that a variety of core hardware configurations may be utilized for a node functioning as system cache.

Node 700 may operate as a computational node or as system cache based on a setting of node 700, for example a setting stored in configuration logic 711 of core 701. Configuration logic 711 may configure core 701 to function as the system cache. For example, configuration logic 711 may initiate or enable system cache operation and provide parameters for configuring the cache. Memory 712 may be divided into regions. Memory 712 may include a plurality of registers such as registers 719, 720, and 721. Although three registers are shown, memory 712 may include any number of registers. Memory 712 may be partitioned into a plurality of sections, such as tag valid section 715, tag section 716, data valid section 717, and data section 718. Core 701 may be programmable to modify the sections of memory 712. For example, core 701 may make a modification to a tag width of a plurality of tags within tag section 716, to a data width of a plurality of data locations within data section 718, to an overall amount of memory allocated to each of the sections 715, 716, 717, and 718 of memory 712, or a combination of modifications. Modifications may be based on the computation requirements of a workload.

RISC processing unit 709 may be configured to send and receive messages. For example, RISC processing unit 709 may send trigger address 722 to register 720. The trigger address may be for the system cache and may be a tag start address. Processors 713 may parse a received cache access request 727 to RISC processing unit 709, which in turn may service request 727 via trigger address 722 to register 720. For example, cached data may include a tag that is utilized to provide an address that can be requested by other nodes as well as associated data for the tag.

Hardware accelerator 710 may automatically perform system cache management operations of memory 712 based on configuration logic 711 and trigger address 722, which is communicated between RISC processing unit 709 and memory 712. Hardware accelerator 710 may be coupled to communication path 714. Hardware accelerator 710 may monitor communication between RISC processing unit 709 and memory 712 for trigger address 722 (e.g., monitor communication path 714). That is, hardware accelerator 710 may “snoop” communication path 714 between RISC processing unit 709 and the registers of memory 412 (e.g., register 720) for a particular trigger message such as trigger address 722 or a different tag start address, which may trigger hardware accelerator 710 to perform cache access and analysis operations.

In specific embodiments, a tag address may be accessed to query for within the system cache via configuration logic 711. Hardware accelerator 710 may be configured to access requested tag value 726 for the requested tag from configuration register 725. Configuration logic 711 may include information about which tag start addresses (e.g., a range of tag start addresses), if any, are considered trigger addresses. Hardware accelerator 710 may access the requested address via configuration logic 711 to perform tag search and management operations. Requested tag value 726 may be accessed from configuration register 725 after the communication including trigger address 722 is monitored.

Hardware accelerator 710 may detect trigger address 722. In response to detecting trigger address 722 (e.g., detecting a communication including trigger address 722), hardware accelerator 710 may query one or more of the plurality of sections of the memory 712 for information about the requested tag (e.g., tag valid section 715, tag section 716, data valid section 717, and/or data section 718). For example, hardware accelerator 710 may send query 724 to tag valid section 715 to determine whether the tag is valid. Tag valid section 715 may include a plurality of tag valid fields. Each tag valid field may be associated with a corresponding tag within tag section 716 and may indicate whether the corresponding tag is valid.

The query may include searching tags within tag section 716 for the requested tag. Each tag of a plurality of tags within tag section 716 may be associated with a corresponding data location within data section 718. The query process may include hardware accelerator 710 making a determination that the requested tag is present as a first tag within tag section 716.

Data valid section 717 may include a plurality of data valid fields, wherein each data valid field of the plurality of data valid fields may be associated with one of the plurality of tags and its associated data location. The query process may include a check of a data valid field associated with the first tag. If the tag and data are valid, hardware accelerator 710 may return an address that can be used to access the data associated with the tag. Hardware accelerator 710 may generate a first output value (such as 0) if the information about the requested tag indicates that data is unavailable for the requested tag. The first output value may be generated if the information about the requested tag indicates that the requested tag is invalid or that data associated with the requested tag is invalid. Hardware accelerator 710 may generate a second output value (such as a reference to the data location) if the information about the requested tag indicates that the data is available for the requested tag. The second output value may be generated if the information about the requested tag indicates that the requested tag was found within the memory and that data associated with the requested tag is valid. The second output value may include a reference to the data location associated with the requested tag. The reference to the data location may include an incremented offset value for the data location (e.g., offset+1).

Hardware accelerator 710 may provide message 723 (including either the first output value or the second output value) to register 719 based on query 724. The first output value may be provided to register 719 if the data valid field indicates that a first data location associated with the requested tag is invalid. The second output value may be provided to register 719 if the data valid field indicates that a first data location associated with the requested tag is valid. RISC processing unit 709 may receive, via register 719, message 723. Message 723 may have a first output value (such as 0) if a requested tag is unavailable or a second output value (such as 1 or another nonzero value) if the requested tag is available.

Hardware accelerator 710 relieves RISC processing unit 709 of performing sequential load and access operations to match requested tags to tags within memory 712. The partitioning of memory 712 allows hardware accelerator 710 to efficiently search the memory of the system cache for requested tags and perform other operations such as tag and data validation.

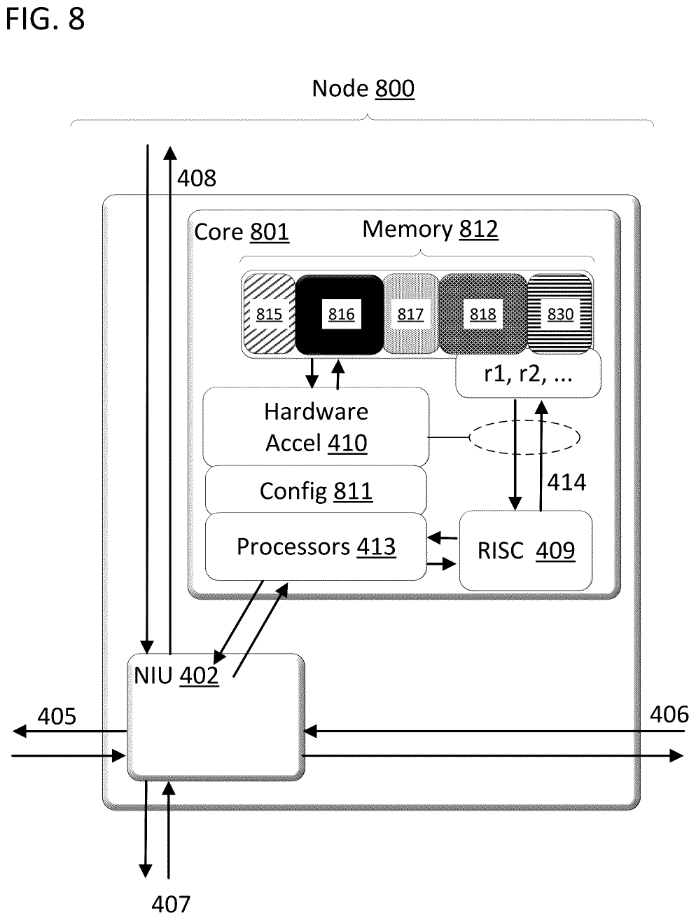

FIG. 8 depicts node 800, which is partially repurposed as system cache with hardware acceleration, where node 800 maintains some cache as a local cache in accordance with an embodiment of the present disclosure. Node 800 may be similar to node 400 with a different setting via configuration logic 811. The structure and components of node 800 are simplified for purposes of describing the relevant system cache operations for purposes of the present disclosure. While core 801 is depicted with particular components relevant to the present disclosure including processors 413 (e.g., CPUs, GPUs, etc.), at least one RISC CPU 409, a system cache hardware accelerator 410, configuration logic 811 for hardware accelerator 410, and memory 812 including multiple addressable registers r1, r2, etc., it will be understood that a variety of core hardware configurations may be utilized in accordance with the present disclosure.

Cache configuration messages and cache access requests are received at core 801, for example, from other nodes within a network via NIU 402 and any of communication paths 405, 406, 407, and/or 408. As is depicted in FIG. 8, RISC CPU 409 communicates with memory 812 of core 801 (e.g., via registers r1, r2, etc.) via communication path 414. Processing core 801 is configured (e.g., via configuration logic 811) to partition the L1 memory into particular sections 815, 816, 817, 818, and 830. Section 815 may be a tag valid section, section 816 may be a tag section, section 817 may be a data valid section, and section 818 may be a data section. Section 830 may not be part of the system cache but rather may be a portion of memory 812 that remains specific to node 800. That is, only part of memory 812 may be repurposed as system cache.

Hardware accelerator 410 may automatically perform system cache management operations of sections 815 through 818, which belong to the system cache memory, based on configuration logic 811 and messages that are communicated between RISC CPU 409 and memory 812 (e.g., via register load operations). Hardware accelerator 410 may thus relieve RISC CPU 409 of performing sequential load and access operations to match requested tags to tags. The partitioning of memory 812 into sections 815 through 818 allows hardware accelerator 410 to efficiently search the memory of the system cache for requested tags and perform other operations such as tag and data validation. RISC CPU 409 (e.g., not hardware accelerator 410) may perform functions related to section 830, the portion of memory 812 that remains a local (rather than system) cache for node 800. That is, RISC CPU 409 may search section 830 of memory 812 for requested tags and perform other operations such as tag and data validation.

Cache configuration messages may configure core 801 to partially function as the system cache, for example, by initiating or enabling system cache operation and providing parameters for configuring the cache. For example, configuration of core 801 as a system cache may include explicit allocations of memory section 815, 816, 817, 818, and 830, including overall size, tag and data size, number of tags, trigger addresses and the like. In some examples, some or all of the configuration can be performed automatically by core 801, with core 801 providing some or all of the information necessary for the system to address the cache to other nodes. Cache access requests may then trigger hardware accelerated cache access, for example, with another node providing a tag address to access. Operations may be split between RISC CPU 409 and hardware accelerator 410. For example, RISC CPU 409 may provide a load message to a register of memory 812 including the trigger address (e.g., a configured address such as a tag start address that is already an existing address/message for core 801 memory access requests) that refers to a tag in the shared cache. Hardware accelerator 410 may access the requested address via configuration logic 811 to perform the tag search and management operations. For example, hardware accelerator 410 may “snoop” communication path 414 between RISC CPU 409 and the registers of memory 812 for a particular trigger message such as a tag start address referring to a tag in the system cache, which may trigger hardware accelerator 410 to perform cache access and analysis operations. Hardware accelerator 410 may be reconfigured, while memory 812 is being partitioned, through the programming of multiplexers or control registers, to effectively wire the hardware accelerator 410 to the appropriate portions of memory 812 for receiving the required control or command signals from hardware accelerator 410 in response to a particular trigger message. If a message between RISC CPU 409 and the registers of memory 812 includes a tag start address that is not part of the shared system cache, then hardware accelerator 410 may refrain from performing cache access or analysis operations. Instead, RISC CPU 409 may perform the associated cache and analysis operations for the local (not shared) system cache tag start address. The cache and analysis operations for the local (not shared) system cache tag start address may include access to section 830.

In the example of FIG. 8, only part of core 801 is repurposed as system cache. The mix of system cache functionality and computational core functionality may be beneficial for workloads which have lower memory footprint within a node. For such workloads, node 800 may use a portion of its L1 cache (e.g., section 830) and repurpose unused portions of the L1 cache (e.g., sections 815 through 818) as part of the system cache.

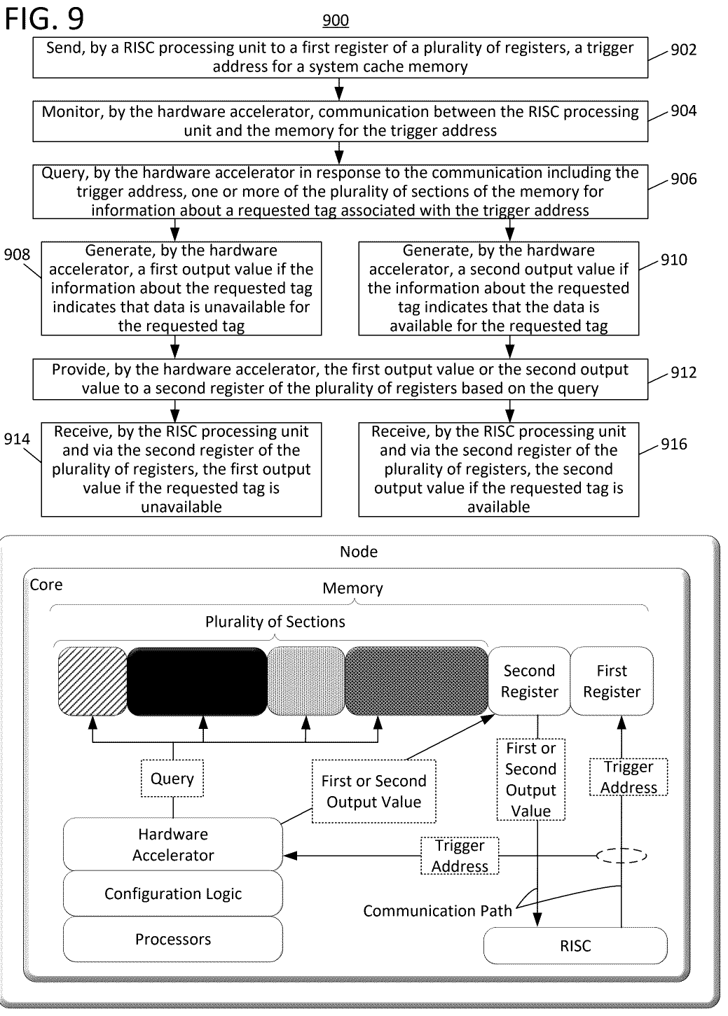

FIG. 9 depicts an example method 900 for operating a hardware-accelerated system cache memory within a network of computational nodes in accordance with specific embodiments of the inventions disclosed herein. A system implementing method 900 may include a node including a core that may be configured as the system cache memory. The core may include a memory, a RISC processing unit, and a hardware accelerator. The memory may be partitioned into a plurality of sections and may include a plurality of registers. In specific embodiments, the plurality of sections of the memory may include a tag valid section, a tag section, a data valid section, a data section, or a combination thereof. In specific embodiments, the core may be programmable to modify one or more of the plurality of sections of the memory. The determination to repurpose some or all of the memory of a node to be a system cache may depend on the computation requirements of a workload. Steps or portions of steps of method 900 may be rearranged, duplicated, omitted, or otherwise deviate from the form shown. In specific embodiments, steps may be added to method 900.

At step 902, a RISC processing unit may send a trigger address for a system cache memory to a first register of a plurality of registers. The RISC processing unit may be coupled to a memory by a communication path. In specific embodiments, the trigger address may be a tag start address.

At step 904, the hardware accelerator may monitor communication between the RISC processing unit and the memory for the trigger address. The hardware accelerator may be coupled to the communication path. In specific embodiments, the hardware accelerator may snoop the communication path. In specific embodiments, the hardware accelerator may be configured to access a requested tag value for the requested tag from a configuration register. The requested tag value may be accessed from the configuration register after the communication including the trigger address is monitored.

At step 906, the hardware accelerator may query, in response to the communication including the trigger address, one or more of the plurality of sections of the memory for information about a requested tag associated with the trigger address.

In specific embodiments, the plurality of sections may include a tag valid section and a tag section. The tag valid section may include a plurality of tag valid fields, where each tag valid field may be associated with a corresponding tag within the tag section and may indicate whether the corresponding tag is valid. In specific embodiments, the query may include searching tags within the tag section for the requested tag. In specific embodiments, as a result of the query, a tag valid field corresponding to the requested tag may be updated. For example, the hardware accelerator may perform a tag validity check on the identified tag by checking a tag valid field associated with the tag or performing verification operations for cache coherence for the tag value. If the tag is determined to be invalid, an associated tag invalid field may be updated. As another example, the hardware accelerator may perform a data validity check for the data associated with the tag address based on the binary value of an associated data valid tag, coherence protocols, or cache eviction. If the data associated with the tag is determined to be invalid, the associated data invalid field may be updated.

In specific embodiments, the system may include a data valid section including a plurality of data valid fields, where each data valid field of the plurality of data valid fields may be associated with one of the plurality of tags and the associated data location of the one of the plurality of tags. In specific embodiments, the system may include a data section, where each tag of a plurality of tags within the tag section may be associated with a corresponding data location within the data section. The query may include the hardware accelerator making a determination that the requested tag is present as a first tag within the tag section and may include a check of a first data valid field associated with the first tag.

In specific embodiments, the core may be programmable to modify one or more of the plurality of sections of the memory. In specific embodiments, the modification to the one or more of the plurality of sections of the memory may include a modification to a tag width of a plurality of tags within one of the sections of the memory (e.g., a tag section). In specific embodiments, the modification of the one or more of the plurality of sections of the memory may include a modification to a data width of a plurality of data locations within one of the sections of the memory (e.g., a data section). In specific embodiments, the modification of the one or more of the plurality of sections of the memory may include modifying an overall amount of memory allocated to the plurality of sections of the memory (e.g., a tag valid section, a tag section, a data valid section, a data section, and a local memory section). In specific embodiments, the memory may not be completely repurposed as a system memory but may retain a portion of the memory (e.g., of the L1 cache) for computations.

At step 908, the hardware accelerator may generate a first output value if the information about the requested tag indicates that data is unavailable for the requested tag. In specific embodiments, first output value may be generated if the information about the requested tag indicates that the requested tag is invalid or that data associated with the requested tag is invalid.

At step 910, the hardware accelerator may generate a second output value if the information about the requested tag indicates that data is available for the requested tag. In specific embodiments, the second output value may be generated if the information about the requested tag indicates that the requested tag was found within the memory and that data associated with the requested tag is valid. In specific embodiments, the second output value may include reference to the data location associated with the requested tag. The reference to the data location may include an incremented offset value for the data location (e.g., offset+1).

At step 912, the hardware accelerator may provide the first output value (e.g., generated at step 908) or the second output value (e.g., generated at step 910) to a second register of the plurality of registers based on the query. In specific embodiments, the first output value may be provided to the second register if the first data valid field indicates that a first data location associated with the requested tag is invalid. In specific embodiments, the second output value may be provided to the second register if the first data valid field indicates that a first data location associated with the requested tag is valid.

At step 914, the RISC processing unit may receive, via the second register, the first output value if the requested tag is unavailable.

At step 916, the RISC processing unit may receive, via the second register, the second output value if the requested tag is available.

A network of computational nodes using shared resources, such as a shared memory, can be beneficial for various workloads. For example, shared resources benefit artificial intelligence workloads because the output of one computational node is often the input to the next computational node. For example, a first computational node could be conducting computations for a first layer of an ANN and a second computational node could be conducting computations for a second layer of an ANN and the second core could start executing as soon as a portion of the data was available as an output from the first layer. As another example, the first computational node could be conducting a large number of multiplication operations and the second computational node could be accumulating the calculated values. In either case, the use of a shared resource such as a shared cache is beneficial because the outputs of one computational unit are readily available to be used as the inputs of a second computational unit. Accordingly, increasing the amount of shared cache by repurposing one or more nodes may improve the efficiency of the network in completing the workload. The quantity of nodes that are repurposed as shared cache, and the extent to which the nodes are repurposed as shared cache, may depend on computational requirements of the workload. The hardware accelerator relieves the processors of performing sequential load and access operations to match requested tags to tags within the system memory. The partitioning of the system memory allows the hardware accelerator to efficiently search the memory of the system cache for requested tags and perform other operations such as tag and data validation.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to a core of a node in a computational network repurposed as a shared system memory, the same approaches could be utilized to improve memory access for a variety of memory configurations. As another example, while a RSIC CPU or RISC processor generally were provided as examples of processors that would be sending requests to the memory which would be snooped by the hardware accelerator, any processing unit could be used in place of those processors in certain embodiments and certain benefits in terms of alleviating the processing burden on those processing units could be realized. These and other modifications and variations to the present invention may be practiced by those skilled in the art, without departing from the scope of the present invention, which is more particularly set forth in the appended claims.

What is claimed is:

1. A system for operating a hardware-accelerated system cache memory within a network of computational nodes, comprising:
a node including a core configured as a system cache memory, wherein the core comprises:
a memory partitioned into a plurality of sections and including a plurality of registers;
a reduced instruction set computer (“RISC”) processing unit coupled to the memory by a communication path, wherein the RISC processing unit is configured to:
send, to a first register of the plurality of registers, a trigger address for the system cache;
receive, via a second register of the plurality of registers, a first output value if a requested tag is unavailable; and
receive, via the second register of the plurality of registers, a second output value if the requested tag is available; and
a hardware accelerator coupled to the communication path and configured to:
monitor communication between the RISC processing unit and the memory for the trigger address;
query, in response to the communication including the trigger address, one or more of the plurality of sections of the memory for information about the requested tag;
generate the first output value if the information about the requested tag indicates that data is unavailable for the requested tag;
generate the second output value if the information about the requested tag indicates that the data is available for the requested tag; and
provide the first output value or the second output value to the second register of the plurality of registers based on the query.

2. The system of claim 1, wherein the plurality of sections include a tag valid section and a tag section.

3. The system of claim 2, wherein the tag valid section includes a plurality of tag valid fields, wherein each tag valid field is associated with a corresponding tag within the tag section and indicates whether the corresponding tag is valid.

4. The system of claim 3, wherein, as a result of the query, a tag valid field corresponding to the requested tag is updated.

5. The system of claim 3, wherein the query comprises searching tags within the tag section for the requested tag.

6. The system of claim 2, further comprising a data section, wherein each tag of a plurality of tags within the tag section is associated with a corresponding data location within the data section, and wherein the second output value comprises a reference to the data location associated with the requested tag.

7. The system of claim 6, wherein the reference to the data location comprises an incremented offset value for the data location.

8. The system of claim 6, further comprising a data valid section including a plurality of data valid fields, wherein each data valid field of the plurality of data valid fields is associated with one of the plurality of tags and its associated data location.

9. The system of claim 8, wherein the query includes the hardware accelerator making a determination that the requested tag is present as a first tag within the tag section and a check of a first data valid field associated with the first tag, and wherein the first output value is provided to the second register if the first data valid field indicates that a first data location associated with the requested tag is invalid.

10. The system of claim 1, wherein the core is programmable to modify one or more of the plurality of sections of the memory.

11. The system of claim 10, wherein the modification to the one or more of the plurality of sections of the memory comprises a modification to a tag width of a plurality of tags within one of the sections of the memory.

12. The system of claim 11, wherein the modification of the one or more of the plurality of sections of the memory comprises a modification to a data width of a plurality of data locations within one of the sections of the memory.

13. The system of claim 11, wherein the modification of the one or more of the plurality of sections of the memory comprises modifying an overall amount of memory allocated to the plurality of sections of the memory.

14. The system of claim 1, wherein the first output value is generated if the information about the requested tag indicates that the requested tag is invalid or that data associated with the requested tag is invalid.

15. The system of claim 1, wherein the second output value is generated if the information about the requested tag indicates that the requested tag was found within the memory and that data associated with the requested tag is valid.

16. The system of claim 1, wherein the hardware accelerator is further configured to access a requested tag value for the requested tag from a configuration register, and wherein the requested tag value is accessed from the configuration register after the communication including the trigger address is monitored.

17. The system of claim 1, wherein the trigger address is a tag start address.

18. A method for operating a hardware-accelerated system cache memory within a network of computational nodes, comprising:
sending, by a reduced instruction set computer (“RISC”) processing unit to a first register of a plurality of registers, a trigger address for a system cache memory, the RISC processing unit being coupled to a memory by a communication path, the memory being partitioned into a plurality of sections, the plurality of registers being part of the memory, and wherein the memory, the RISC processing unit, and a hardware accelerator are part of a core configured as the system cache memory;
monitoring, by the hardware accelerator, communication between the RISC processing unit and the memory for the trigger address, the hardware accelerator being coupled to the communication path;
querying, by the hardware accelerator in response to the communication including the trigger address, one or more of the plurality of sections of the memory for information about a requested tag associated with the trigger address;
generating, by the hardware accelerator, a first output value if the information about the requested tag indicates that data is unavailable for the requested tag;
generating, by the hardware accelerator, a second output value if the information about the requested tag indicates that the data is available for the requested tag;
providing, by the hardware accelerator, the first output value or the second output value to a second register of the plurality of registers based on the query;
receiving, by the RISC processing unit and via the second register of the plurality of registers, the first output value if the requested tag is unavailable; and
receiving, by the RISC processing unit and via the second register of the plurality of registers, the second output value if the requested tag is available.

19. The method of claim 18, wherein the plurality of sections include a tag valid section, a tag section, a data valid section, and a data section.

20. A system for operating a hardware-accelerated system cache memory within a network of computational nodes, comprising:
a node including a core configured partially as a system cache memory, wherein the core comprises:
a memory partitioned into a plurality of sections and including a plurality of registers, wherein at least one section of the plurality of sections functions as a system cache for the network of computational nodes and at least one other section of the plurality of sections functions as a local cache for the node;
a reduced instruction set computer (“RISC”) processing unit coupled to the memory by a communication path, wherein the RISC processing unit is configured to:
send, to a first register of the plurality of registers, a trigger address for the system cache;
receive, via a second register of the plurality of registers, a first output value if a requested tag is unavailable; and
receive, via the second register of the plurality of registers, a second output value if the requested tag is available; and
a hardware accelerator coupled to the communication path and configured to:
monitor communication between the RISC processing unit and the memory for the trigger address;
query, in response to the communication including the trigger address, one or more of the at least one section that functions as the system cache for information about the requested tag;
generate the first output value if the information about the requested tag indicates that data is unavailable for the requested tag;
generate the second output value if the information about the requested tag indicates that the data is available for the requested tag; and
provide the first output value or the second output value to the second register of the plurality of registers based on the query.
